(19) United States
(12) Patent Application Publication
(10) Pub. No.: US 2019/0138591 A1
(43) Pub. Date: May 9, 2019

(54) Classifying Third-Party Landing Pages Accessible Via Links

(71) Applicant: Facebook, Inc., Menlo Park, CA (US)

(72) Inventors: Navneet Kesher, Bothell, WA (US); Zuzana Bodik, Kirkland, WA (US)

(21) Appl. No.: 15/803,355

(22) Filed: Nov. 3, 2017

(51) Int. Cl. G06F 17/27; G06F 17/30

(52) U.S. Cl. CPC G06F 17/27; G06F 17/30882; G06F 17/30864; G06F 17/30896; G06F 17/30707

(57) ABSTRACT

In one embodiment, a method includes receiving a request to create a post from a second computing device, where the post includes a link to a landing page outside the online social network and one or more words associated with the link in the post, classifying the link based on the one or more words, where the classification selects one of a plurality of pre-determined classes, and where each class is associated with particular expected content of the landing page, analyzing data from the landing page to generate a determination whether content of the landing page corresponds to the selected class, and assigning a rank to the link based on the determination.

### TECHNICAL FIELD

This disclosure generally relates to determining whether providing a link to a third-party landing page to users of an online social network.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

A mobile computing device—such as a smartphone, tablet computer, or laptop computer—may include functionality for determining its location, direction, or orientation, such as a GPS receiver, compass, gyroscope, or accelerometer. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

In particular embodiments, the social-networking system may determine whether to provide a link associated with a short description, referred to as a Call to Action (CTA), to users of the online social network in their newsfeed or in the search results. The uses may visit a third-party landing page outside the online social network via the link. The social-networking system may classify the CTA into one of a plurality of pre-determined classes. The social-networking system may collect data from the third-party landing page and analyze the collected data to determine whether content of the third-party landing page corresponds to the class associated with the CTA. The social-networking system 160 may determine not to provide the link to the users in their newsfeed or in the search results if content of the third-party landing page does not correspond to the class. The social-networking system may have interfaces that allow the users to create event posts in the online social network, where an event post may comprise details of the planned event and one or more links to third-party landing pages. The event organizing users may be able to connect with their audience and spend time together in the real world through the event posts. When an event organizing user creates an event post including a ticket link, the social-networking system may provide the ticket link to the other online social network users in their newsfeed and their search results. Though the social-networking system may aim to provide quality user experience to the users, the social-networking system may not be able to control content of a third-party landing page connected via a link. A third-party landing page not corresponding to the context of the associated CTA would result in a poor user experience. As an example and not by way of limitation, the social-networking system may receive a request to create an event post regarding a rock concert from a user. The event comprises a link with a CTA “Buy tickets now,” but the landing page connected through the link is not related with the rock concert. If the social-networking system provide the event post to users who are interested in rock music, the users would expect to be able to buy tickets by clicking the link. Because the link does not take the users to ticket selling page, the social-networking system may determine not to provide the event post to the users.

The social-networking system may receive a request to create a post from a second computing device. The post may comprise a link to a landing page outside the online social network and one or more words associated with the link in the post. The social-networking system may classify the link based on the one or more words. The classification may select one of a plurality of pre-determined classes each associated with particular expected content. The social-networking system may determine the class for the link by analyzing a context of the one or more words. The social-networking system may analyze data from the landing page to generate a determination whether content of the landing page corresponds to the selected class. The data may comprise html, text, images, embedding codes, or embedded links. In particular embodiments, the social-networking system may generate the determination based on a code snippet in html of the landing page, where the code snippet was provided by the social-networking system to the second computing device. The code snippet may provide meta-tags describing content of the landing page. In particular embodiments, the social-networking system may generate the determination based on an output of a logistic regression model, where the logistic regression model takes the data and the selected class as input and produces a probability that content of the landing page corresponds to the class. The social-networking system may determine that content of the landing page corresponds to the class if the probability satisfies a third threshold. The logistic regression model may utilize Machine Learning (ML) techniques to classify content of the landing page. In particular embodiments, the ML techniques may comprise Natural Language Processing (NLP)-based text-mining algorithms. In particular embodiments, the ML techniques may comprise image detection algorithms or video detection algorithms. The social-networking system may train the logistic regression model with a large corpus of training data. The training data may comprise both positive training data and negative training data. The social-networking system may train the logistic regression model per each of the pre-determined classes. The social-networking system may collect the positive training data for a particular class from third-party web pages that correspond to the particular class. The social-networking system may collect the negative training data for the particular class from third-party web pages that do not correspond to the particular class. The social-networking system may assign a rank to the link based on the determination. The social-networking system may send, in response to the request, a response comprising the assigned rank to the second computing device. The response includes a description of one or more parameters that negatively impacted the rank. The social-networking system may compute a probability that particular users of the online social network will click the link. The social-networking system may present the post only to the particular users when the probability satisfies a first threshold. In particular embodiments, the post may be presented in newsfeeds of the particular users. In particular embodiments, the post may be presented in search results of the particular users if the post is relevant to search queries from the selected users. The social-networking system may present the post to users in the online social network only when the assigned rank satisfies a second threshold.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIGS. 1A-1C illustrate example scenarios where links associated with CTA connect to third-party landing pages.

FIG. 2 illustrates an example flow for classifying a link on an event page for a third-party landing page.

FIG. 3 illustrates an example logistic regression model for determining a probability for a landing page corresponding to a particular class.

FIG. 4 illustrates an example method for ranking a link for a third-party landing page.

FIG. 5 illustrates an example network environment associated with a social-networking system.

FIG. 6 illustrates an example artificial neural network (“ANN”).

FIG. 7 illustrates an example social graph.

FIG. 8 illustrates an example computer system.

### DESCRIPTION OF EXAMPLE EMBODIMENTS

In particular embodiments, the social-networking system 560 may determine whether to provide a link associated with a short description, referred to as a Call to Action (CTA), to users of the online social network in their newsfeed or in the search results. The uses may visit a third-party landing page outside the online social network via the link. The social-networking system 560 may classify the CTA into one of a plurality of pre-determined classes. The social-networking system 560 may collect data from the third-party landing page and analyze the collected data to determine whether content of the third-party landing page corresponds to the class associated with the CTA. The social-networking system 160 may determine not to provide the link to the users in their newsfeed or in the search results if content of the third-party landing page does not correspond to the class. The social-networking system 560 may have interfaces that allow the users to create event posts in the online social network, where an event post may comprise details of the planned event and one or more links to third-party landing pages. The event organizing users may be able to connect with their audience and spend time together in the real world through the event posts. When an event organizing user creates an event post including a ticket link, the social-networking system 560 may provide the ticket link to the other online social network users in their newsfeed and their search results. Though the social-networking system 560 may aim to provide quality user experience to the users, the social-networking system 560 may not be able to control content of a third-party landing page connected via a link. A third-party landing page not corresponding to the context of the associated CTA would result in a poor user experience. As an example and not by way of limitation, the social-networking system 560 may receive a request to create an event post regarding a rock concert from a user. The event post comprises a link with a CTA “Buy tickets now,” but the landing page connected through the link is not related to the rock concert. If the social-networking system 560 provides the event post to users who are interested in rock music, the users would expect to be able to buy tickets by clicking the link. Because the link does not take the users to ticket selling page, the social-networking system 560 may determine not to provide the event post to the users. Although this disclosure describes determining whether to provide a link associated with a CTA to users in their newsfeed or in the search results in a particular manner, this disclosure contemplates determining whether to provide a link associated with a CTA to users in their newsfeed or in the search results in any suitable manner.

The social-networking system 560 may receive a request to create a post from a second computing device. The post may comprise a link to a landing page outside the online social network and one or more words associated with the link in the post. The social-networking system 560 may classify the link based on the one or more words. The classification may select one of a plurality of pre-determined classes each associated with particular expected content. The social-networking system 560 may determine the class for the link by analyzing a context of the one or more words. The social-networking system 560 may analyze data from the landing page to generate a determination whether content of the landing page corresponds to the selected class. The data may comprise html, text, images, embedding codes, or embedded links. In particular embodiments, the social-networking system 560 may generate the determination based on a code snippet in html of the landing page, where the code snippet was provided by the social-networking system 560 to the second computing device. The code snippet may provide meta-tags describing content of the landing page. In particular embodiments, the social-networking system 560 may generate the determination based on an output of a logistic regression model, where the logistic regression model takes the data and the selected class as input and produces a probability that content of the landing page corresponds to the class. The social-networking system 560 may determine that content of the landing page corresponds to the class if the probability satisfies a third threshold. The logistic regression model may utilize Machine Learning (ML) techniques to classify content of the landing page. In particular embodiments, the ML techniques may comprise Natural Language Processing (NLP)-based text-mining algorithms. In particular embodiments, the ML techniques may comprise image detection algorithms or video detection algorithms. The social-networking system 560 may train the logistic regression model with a large corpus of training data. The training data may comprise both positive training data and negative training data. The social-networking system 560 may train the logistic regression model per each of the pre-determined classes. The social-networking system 560 may collect the positive training data for a particular class from third-party web pages that correspond to the particular class. The social-networking system 560 may collect the negative training data for the particular class from third-party web pages that do not correspond to the particular class. The social-networking system 560 may assign a rank to the link based on the determination. The social-networking system 560 may send, in response to the request, a response comprising the assigned rank to the second computing device. The response includes a description of one or more parameters that negatively impacted the rank. The social-networking system 560 may compute a probability that particular users of the online social network will click the link. The social-networking system 560 may present the post only to the particular users when the probability satisfies a first threshold. In particular embodiments, the post may be presented in newsfeeds of the particular users. In particular embodiments, the post may be presented in search results for the particular users if the post is relevant to search queries from the selected users. The social-networking system 560 may present the post to users in the online social network only when the assigned rank satisfies a second threshold.

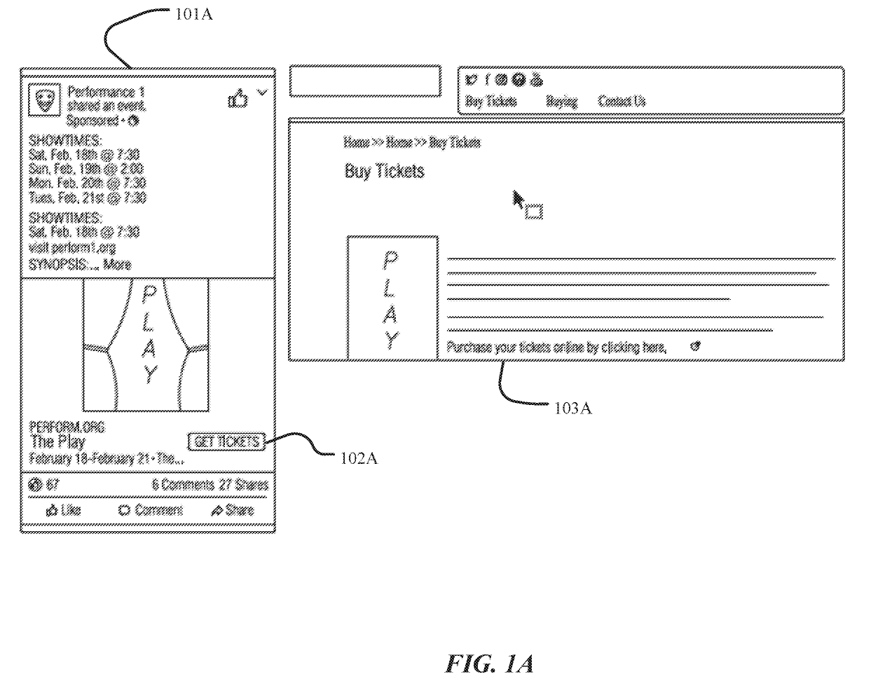

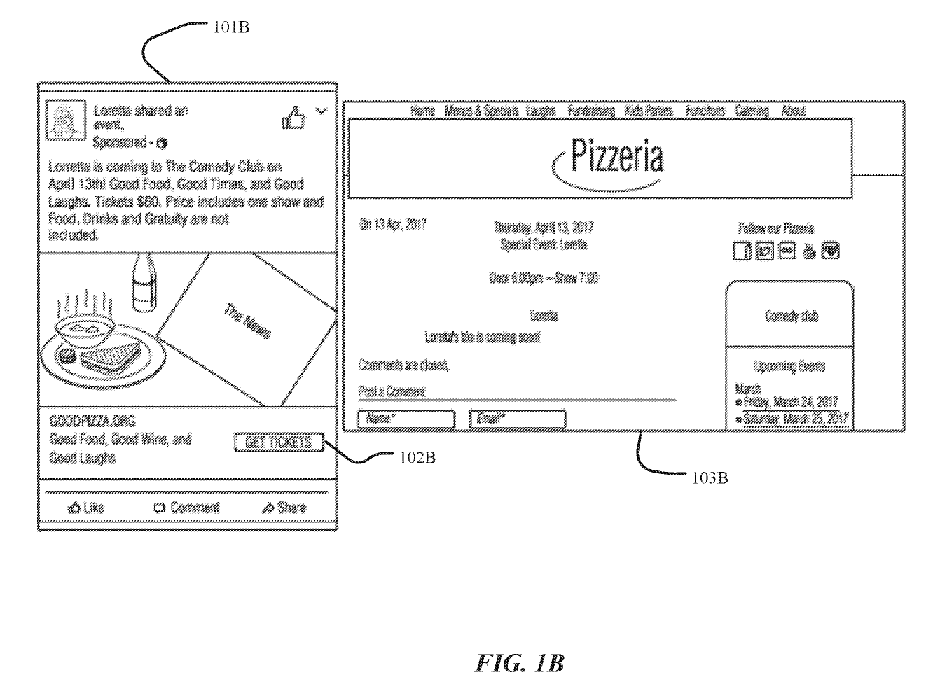

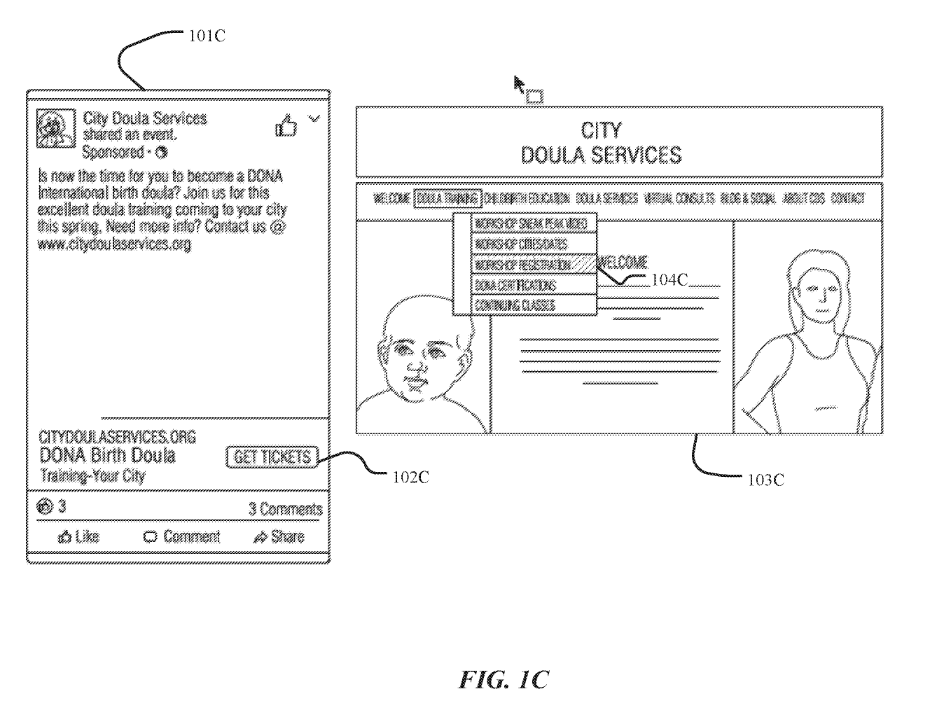

FIGS. 1A-1C illustrate example scenarios where links associated with CTA connect to third-party landing pages. In an example illustrated in FIG. 1A, a theater manager creates an event page 101A to promote a new show. The event page 101A includes a link 102A with a CTA “Get Tickets.” A third-party landing page 103A connected via the link 102A sells tickets for the show. When a user clicks the link 102A because the user is interested in buying tickets for the show, the user will be able to buy tickets on the third-party landing page 103A connected via the link 102A. The social-networking system 560 may rank the link 102A high because the landing page 103A provides what the users would expect. In an example illustrated in FIG. 1B, Loretta, a comedian, creates an event page 101B to promote an upcoming comedy show of herself at a restaurant. The event page 101B includes a link 102B with a CTA “Get Tickets.” The link 102B is connected to a webpage 103B of the restaurant that announces the upcoming comedy show of Loretta. However, the landing page 103B connected via the link 102B does not sell tickets for the comedy show of Loretta. When a user clicks the link 102B because the user is interested in buying tickets for the comedy show, the user will not be able to buy tickets on the landing page 103B. The social-networking system 560 may want to avoid such situation because the situation yields a bad user experience. The social-networking system 560 may rank the link 102B low because the landing page 103B does not provide what the users expect at all. In an example illustrated in FIG. 1C, a doula service provider creates an event page 101C to announce a doula training program. The event page 101C include a link 102C with a CTA “Get Tickets.” The landing page 103C connected via the link 102C does not sell tickets, but the landing page 103C comprises a drop-down menu “Doula Training->Workshop Registration” 104C that connects to a registration page where people can register for the doula training program. When a user clicks the link 102C because the user is interested in registering for the training program, the user visits the third-party landing page 103C and may be able to find the menu 104C for registration. The social-networking system 560 may rank the link 102C low because the landing page 103C does not directly provide what the users expect on the landing page 103C.

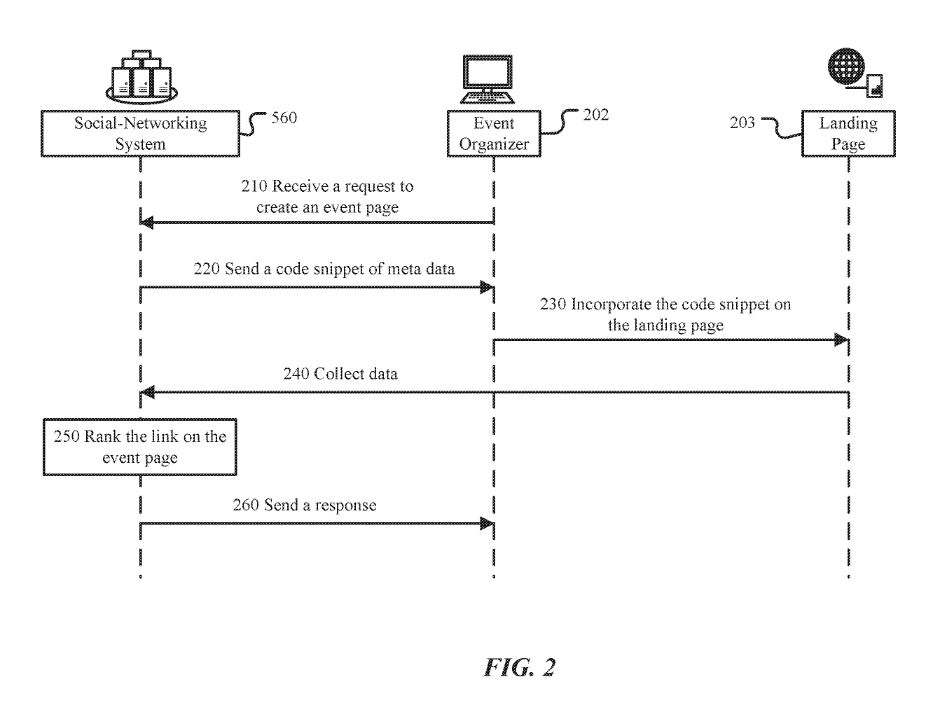

FIG. 2 illustrates an example flow for classifying a link on an event page for a third-party landing page. At step 210, the social-networking system 560 may receive, from a computing device 202 associated with an event organizer, a request to create an event page. The event page may comprise a link to a third-party landing page and a CTA associated with the link. At step 220, the social-networking system 560 may send a code snippet of metadata to the computing device 202. The code snippet may be based on the CTA associated with the link. At step 230, the computing device 202 associated with the event organizer, or any computing device associated with the event organizer, may incorporate the received code snippet into the HTML of the landing page 203. At step 240, the social-networking system 560 may collect data from the landing page 203. The data may comprise HTML, text, images, embedding codes, embedded links, or any suitable form of data. At step 250, the social-networking system 560 may rank the link on the event page. In order to rank the link, the social-networking system 560 may analyze the collected data. At step 260, the social-networking system 560 may send a response to the computing device 202 associated with the event organizer. Although this disclosure describes a sequence flow to rank a link on an event page in a particular manner, this disclosure contemplates any sequence flow to rank a link on an event page in any suitable manner.

The social-networking system 560 may receive a request to create a post from a second computing device 202 at step 210. The second computing device 202 may be associated with a user who wants to promote an event. The post may comprise details of the planned event and a link to a landing page 203 outside the online social network and one or more words associated with the link in the post. The one or more words associated with the link may be referred to as a Call-to-Action (CTA). The CTA may describe a particular purpose of the associated link. The particular purpose may belong to one of a plurality of pre-determined purposes. As an example and not by way of limitation, as illustrated in FIG. 1A, the social-networking system 560 may receive a request to post an event page for a stage show. The event page may comprise a synopsis of the show, a list of available show times, and a link with a CTA “Get Tickets.” The CTA “Get Tickets” describes a purpose of the link. In this example, the link may be associated with a third-party page that sells tickets for the show. Although this disclosure describes receiving a request to post an event page comprising a link in a particular manner, this disclosure contemplates receiving a request to post an event page comprising a link in any suitable manner.

The social-networking system 560 may compute a probability that particular users of the online social network will click the link. The social-networking system 560 may present the post only to the particular users when the probability satisfies a first threshold. The event pages may be a way for the social-networking system 560 to allow the users to connect their audience and spend time together with the audience in the real world. To fulfill the purpose, the social-networking system 560 may need to present the event pages comprising one or more links to third-party landing pages to the potential audience. The social-networking system 560 may compute a probability that a particular user of the online social network is interested in an event described in the event page and click the link on the event page to access a third-party page. The social-networking system 560 may present the event page to the particular user if the probability satisfies the first threshold. In particular embodiments, the social-networking system 560 may present the event page to the particular user in newsfeeds of the particular user. In particular embodiments, the social-networking system 560 may present the event page to the particular user in search results for the particular user if the event page is relevant to a search query from the particular user. As an example and not by way of limitation, the social-networking system 560 may calculate a probability that Bob, an online social network user, is interested in the performance introduced on the event page illustrated in FIG. 1A, and clicks the link on the event page. Bob has posted a number of reviews on performances during the last pre-determined period of time. Also, the calendar of Bob indicates that Bob has visited theaters a number of times during the last pre-determined period of time. The probability computed by the social-networking system 560 based on collected data regarding Bob may be higher than a threshold. The social-networking system 560 may present the event page for the performance to Bob in his newsfeed. As another example and not by way of limitation, the social-networking system 560 may receive a search request “baby birth helper” from Alice, another online social network user. The social-networking system 560 may present the event page illustrated in FIG. 1C in the search results for Alice because the probability that Alice is interested in a Doula training is higher than a threshold. Although this disclosure describes presenting an event page to a particular user in a particular manner, this disclosure contemplates presenting an event page to a particular user in any suitable manner.

The social-networking system 560 may classify the link based on the one or more words associated with the link. The one or more words associated with the link may be referred to as a CTA. The one or more words associated with the link may describe a particular purpose of the link. The particular purpose may belong to one of a plurality of pre-determined purposes. Each of the pre-determined purposes may be classified as a particular class. The classes may comprise ticket sales, e-commerce, gaming, or any suitable purpose. The classification may select one of a plurality of pre-determined classes, where each class is associated with particular expected content of the landing page. The social-networking system 560 may determine the class for the link by analyzing a context of the one or more words. As an example and not by way of limitation, the social-networking system 160 may analyze the context of the CTA associated with the link on the event page illustrated in FIG. 1A. The analysis may be based on a list of pre-identified keywords. In particular embodiments, the social-networking system 160 may analyze the context of the CTA using Natural Language Processing (NLP) techniques. Based on the analysis, the social-networking system 560 may classify the link on the event page illustrated in FIG. 1A as a “ticket sales” link. As another example and not by way of limitation, the social-networking system 560 may receive a request to post an event page promoting a new online game. The event page may comprise a link associated with a CTA “Play Now.” The social-networking system 160 may analyze the CTA and classify the link as a “Gaming” link based on the analysis. Although this disclosure describes classifying a link by analyzing associated CTA in a particular manner, this disclosure contemplates classifying a link by analyzing associated CTA in any suitable manner.

In particular embodiments, the social-networking system 560 may generate the determination whether content of the landing page 203 corresponds to the selected class based on a code snippet in HTML of the landing page. The social-networking system 560 may provide a code snippet to the second computing device 202 associated with the event organizer at step 220. The second computing device 202 associated with the event organizer may incorporate the code snippet in the HTML of the landing page 203 at step 230. After the social-networking system 560 collects data from the landing page 203, the social-networking system 560 may determine whether content of the landing page 203 corresponds to the selected class based on the code snippet in HTML. The code snippet may provide meta-tags describing content of the landing page. As an example and not by way of limitation, the social-networking system 560 may prepare a plurality of code snippets corresponding to the pre-determined classes of the link. When the social-networking system 560 receives a request to post an event page from a second computing device 202, the social-networking system 560 may classify the link on the event page by analyzing the associated CTA. The social-networking system 560 may send a respective code snippet to the second computing device 202. The second computing device 202 may incorporate the received code snippet in HTML of the landing page 203. The social-networking system 560 may determine whether content of the landing page 203 corresponds to the class of the link based on the code snippet in HTML. Although this disclosure describes determining whether content of the landing page corresponds to the class of the link based on a code snippet in HTML in a particular manner, this disclosure contemplates determining whether content of the landing page corresponds to the class of the link based on a code snippet in HTML in any suitable manner.

The social-networking system 560 may analyze data from the landing page to generate a determination whether content of the landing page corresponds to the selected class. The data may comprise HTML, text, images, embedding codes, or embedded links. Landing pages connected via links of a particular class may have particular characteristics. The social-networking system 560 may have identified those particular characteristics for a particular class by analyzing a large corpus of sampled landing pages. The social-networking system 560 may analyze the collected data from a landing page to compute a probability that content of the landing page corresponds to a particular class. The probability may be computed based on a degree of similarities between characteristics of the landing page and the particular characteristics of the particular class. As an example and not by way of limitation, the social-networking system 560 may collect data from a landing page connected via a “ticket sales” link. The social-networking system 560 may find that the landing page includes calendar handling JavaScript codes. The social-networking system 560 may determine that a probability for content of the landing page corresponding to the “ticket sales” class is high because calendar handling JS codes are found in many “ticket sales” landing pages. As another example and not by way of limitation, the social-networking system 560 may collect data from a landing page connected via a “gaming” link. The social-networking system 560 may find that the landing page comprises animated images and two buttons: a “Play Now” button and a “Watch Trailer” button. Because those components are likely found in “gaming” landing pages, the social-networking system 560 may determine a probability for content of the landing page corresponding to the “gaming” class is high. Although this disclosure describes determining a probability that content of a landing page corresponds to the selected class for the link in a particular manner, this disclosure contemplates determining a probability that content of a landing page corresponds to the selected class for the link in any suitable manner.

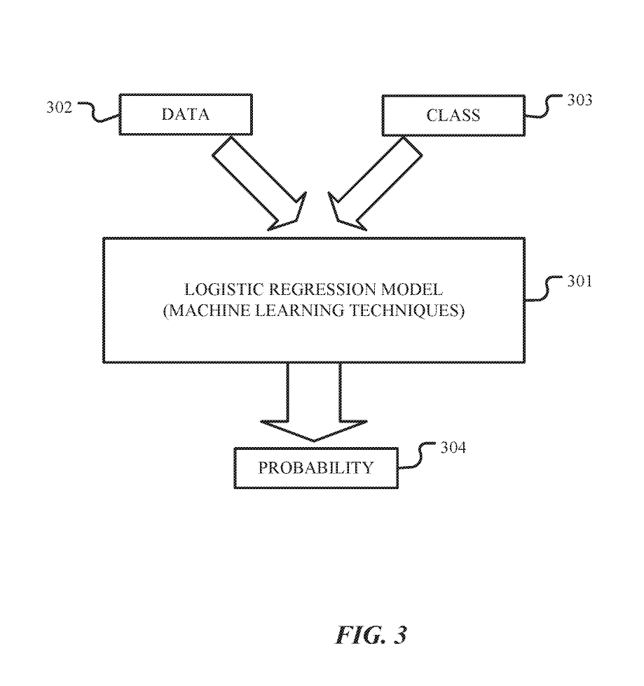

FIG. 3 illustrates an example logistic regression model for determining a probability for a landing page corresponding to a particular class. In particular embodiments, the social-networking system 560 may generate the determination based on an output of a logistic regression model 301, where the logistic regression model takes the data 302 and the selected class 303 as input and produces a probability 304 that content of the landing page corresponds to the class. The social-networking system 560 may determine that content of the landing page corresponds to the class 303 if the probability satisfies a third threshold. As an example and not by way of limitation, illustrated in FIG. 1A, the social-networking system 560 may collect data from the third-party landing page 103A. The social-networking system 560 may provide the collected data and “ticket sales” class as input to a logistic regression model 301. The logistic regression model 301 may utilize ML techniques for analysis and produce a probability 304 that content of the landing page corresponds to the “ticket sales” class. As the probability 304 is higher than a threshold, the social-networking system 560 may determine that content of the landing page corresponds to the “ticket sales” class. Although this disclosure describes determining whether content of the landing page corresponds to the class in a particular manner, this disclosure contemplates determining whether content of the landing page corresponds to the class in any suitable manner.

In particular embodiments, the logistic regression model 301 may utilize Machine Learning (ML) techniques to classify content of the landing page. Machine learning is an application of artificial intelligence (AI) that provides systems ability to automatically learn and improve from experience without being explicitly programmed. In order for the logistic regression model 301 to be able to automatically compute a probability that content of a landing page corresponds to a particular class, the logistic regression model 301 may need to get trained with data collected from landing pages corresponding to the particular class as well as data collected from landing pages not corresponding to the particular class. The logistic regression model 301 may be able to compute a probability that content of a landing page corresponds to a particular class by comparing analyzed attributes of the landing page with common attributes of the landing pages corresponding to the particular class. In particular embodiments, the ML techniques may comprise Natural Language Processing (NLP)-based text-mining algorithms. In particular embodiments, the ML techniques may comprise image detection algorithms or video detection algorithms. In particular embodiments, the ML techniques may comprise pattern recognition algorithms. In particular embodiments, the ML techniques may utilize Artificial Neural Networks (ANN). As an example and not by way of limitation, the social-networking system 560 may collect data from a third-party landing page that comprises text. The social-networking system 560 may provide the collected data and a selected class to the logistic regression model 301. The logistic regression model 301 may utilize NLP-based text-mining algorithms to analyze the context of text. The analyzed context of text on the third-party landing page may be an attribute when the logistic regression model 301 computes a probability that content of the landing page corresponds to a class. As another example and not by way of limitation, the social-networking system 560 may collect data from a third-party landing page that comprises a number of images. The social-networking system 560 may provide the collected data and a selected class to the logistic regression model 301. The logistic regression model 301 may utilize image detection algorithms to analyze the contents of the images. The analyzed contents of the images on the third-party landing page may be an attribute when the logistic regression model 301 computes a probability that content of the landing page corresponds to a class. Although this disclosure describes utilizing ML algorithms to classify content of a landing page in a particular manner, this disclosure contemplates utilizing ML algorithms to classify content of a landing page in any suitable manner.

The social-networking system 560 may train the logistic regression model 301 with a large corpus of training data. The social-networking system 560 may train the logistic regression model 301 per each of the pre-determined classes. In other words, the logistic regression model 301 is a collection of a plurality of ANNs, where each ANN is a machine learning analysis device for each of the pre-determined class, and each ANN may be trained with data different from data for the other ANN. Training the logistic regression model 301 may be a supervised ML training for which training data is pre-labeled. The training data may comprise both positive training data and negative training data. Positive training data may be data collected from landing pages corresponding to the particular class. Negative training data may be data collected from landing pages not corresponding to the particular class. The social-networking system 560 may collect the positive training data for a particular class from third-party web pages that correspond to the particular class. The social-networking system 560 may collect the negative training data for the particular class from third-party web pages that do not correspond to the particular class. As an example and not by way of limitation, the social-networking system 560 may prepare a corpus of training data per each class in the plurality of pre-determined classes. The corpus of training data may comprise both positive training data and negative training data. Both positive training data and negative training data may be labeled accordingly. The social-networking system 560 may train the logistic regression model 301 per each class in the plurality of pre-determined classes. Once the training is over, the logistic regression model 301 may be ready to compute a probability for content of a third-party landing page corresponding to a particular class. The social-networking system 560 may re-train the logistic regression model 301 at a regular interval in order to keep the model reflect up-to-date patterns of the third-party landing pages. Although this disclosure describes training the logistic regression model in a particular manner, this disclosure contemplates training the logistic regression model in any suitable manner.

The social-networking system 560 may assign a rank to the link based on the determination. In particular embodiments, the social-networking system 560 may make a binary determination whether content of a third-party landing page corresponds to a particular class or not. In particular embodiments, the social-networking system 560 may rank a link based on the probability produced by the logistic regression model 301. The social-networking system 560 may treat an event page comprising the link differently based on the rank. The rank may be one of a plurality of pre-determined ranks. As an example and not by way of limitation, illustrated in FIG. 1A, the social-networking system 560 may rank the link 102A high because the logistic regression model 301 produces a high probability that content of the third-party landing page 103A corresponds to the “ticket sales” class. As another example and not by way of limitation, illustrated in FIG. 1B, the social-networking system 560 may rank the link 102B low because the logistic regression model produces a low probability that content of the third-party landing page 103B corresponds to the “ticket sales” class. As yet another example and not by way of limitation, illustrated in FIG. 1C, the social-networking system 560 may rank the link 102C lower than the link 102A but higher than the link 102B because a probability for content of the third-party landing page 103C corresponding to the “ticket sales” class is lower than the probability for the link 102A but higher than the probability for the link 102B. Although this disclosure describes ranking a link for a third-party landing page in a particular manner, this disclosure contemplates ranking a link for a third-party landing page in any suitable manner.

The social-networking system 560 may present the post to users in the online social network only when the assigned rank satisfies a threshold. If the rank is higher than a first threshold, the social-networking system 560 may present the event page comprising the link to any user as long as the probability that the user will click the link on the event page is higher than a pre-determined threshold. If the rank is lower than a second threshold, the social-networking system 560 may not present the event page comprising the link to any user regardless of the probability that the user will click the link on the event page. In particular embodiments, if the rank is in between the first and second thresholds, the social-networking system 560 may present the event page to a user if the probability that the user will click the link on the event page satisfies a third threshold. Typically, the third threshold may be significantly high. The social-networking system 560 may maintain a plurality of ranks and may apply different conditions for presenting associated event pages to users per each rank. As an example and not by way of limitation, illustrated in FIG. 1A, the social-networking system 560 may rank the link 102A high. The social-networking system 560 may present the event page 101A to a user as long as the probability that the user will click the link 102A is high enough. As another example and not by way of limitation, illustrated in FIG. 1B, the social-networking system 560 may rank the link 102B low. The social-networking system 560 may not present the event page 101B to any user. As yet another example and not by way of limitation, illustrated in FIG. 1C, the social-networking system 560 may rank the link 102C lower than 102A but higher than 102B. The social-networking system 560 may present the event page 101C to a user if the probability that the user will click the link 103C is higher than a particular threshold, where the particular threshold is significantly high. Although this disclosure describes presenting an event page to users in a particular manner, this disclosure contemplates presenting an event page to users in any suitable manner.

In particular embodiments, the social-networking system 560 may send, in response to the request, a response to the second computing device. The response may comprise the assigned rank. In particular embodiments, the response may comprise a description of one or more parameters that negatively impacted the rank. On receiving the response, the second computing device may update the third-party landing page based on the description. The updated third-party landing page may correspond to the particular class better. As an example and not by way of limitation, illustrated in FIG. 1B, the social-networking system 560 may send a response to a computing device associated with Loretta. The response may comprise a notice that the event page would not be presented to users because the third-party landing page 103B connected by the link 102B does not sell tickets while the associated CTA indicates that users can buy tickets at the landing page 103B. On receiving the response, Loretta may change the hyperlink URL of the link 102B to a page that sells tickets for the show. Although this disclosure describes sending a response to a computing device associated with the user in a particular manner, this disclosure contemplates sending a response to a computing device associated with the user in any suitable manner.

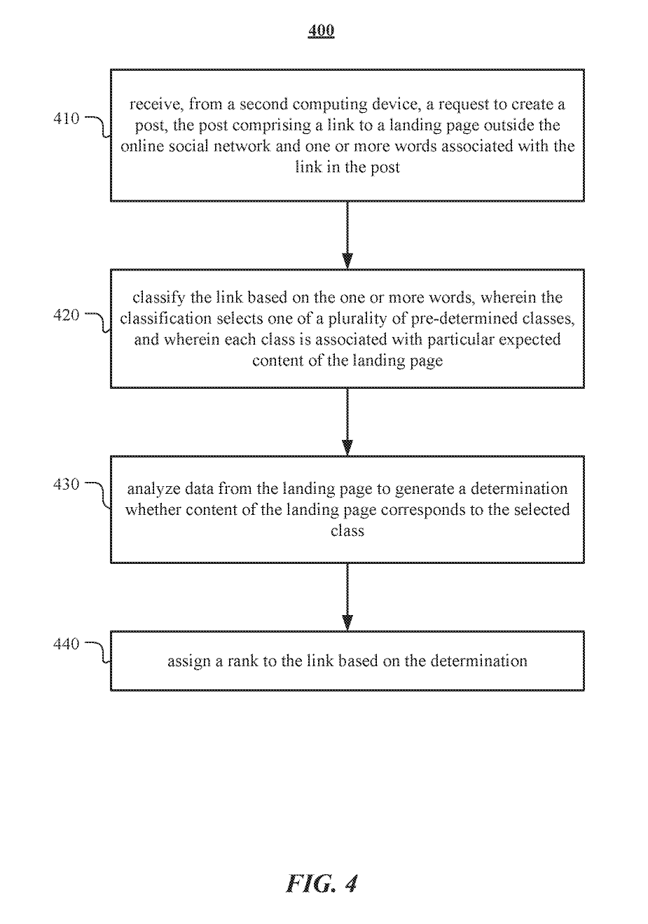

FIG. 4 illustrates an example method 400 for ranking a link for a third-party landing page. The method may begin at step 410, where the social-networking system 560 may receive, from a second computing device, a request to create a post, the post comprising a link to a landing page outside the online social network and one or more words associated with the link in the post. At step 420, the social-networking system 560 may classify the link based on the one or more words, wherein the classification selects one of a plurality of pre-determined classes, and wherein each class is associated with particular expected content of the landing page. At step 430, the social-networking system 560 may analyze data from the landing page to generate a determination whether content of the landing page corresponds to the selected class. At step 440, the social-networking system 560 may assign a rank to the link based on the determination. Particular embodiments may repeat one or more steps of the method of FIG. 4, where appropriate. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates an example method for ranking a link for a third-party landing page including the particular steps of the method of FIG. 4, this disclosure contemplates any suitable method for ranking a link for a third-party landing page including any suitable steps, which may include all, some, or none of the steps of the method of FIG. 4, where appropriate. Furthermore, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

System Overview

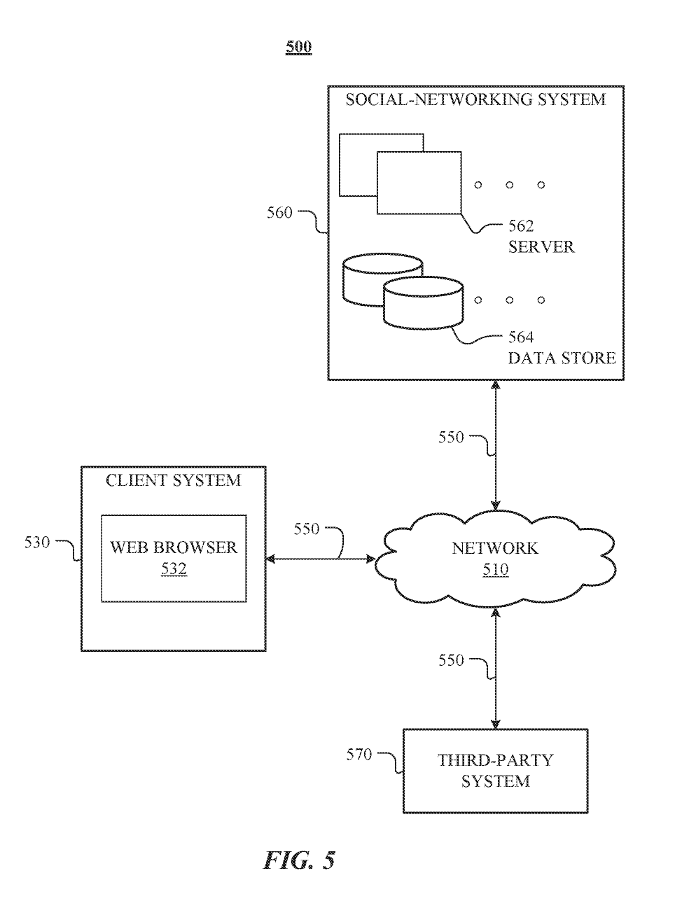

FIG. 5 illustrates an example network environment 500 associated with a social-networking system. Network environment 500 includes a client system 530, a social-networking system 560, and a third-party system 570 connected to each other by a network 510. Although FIG. 5 illustrates a particular arrangement of client system 530, social-networking system 560, third-party system 570, and network 510, this disclosure contemplates any suitable arrangement of client system 530, social-networking system 560, third-party system 570, and network 510. As an example and not by way of limitation, two or more of client system 530, social-networking system 560, and third-party system 570 may be connected to each other directly, bypassing network 510. As another example, two or more of client system 530, social-networking system 560, and third-party system 570 may be physically or logically co-located with each other in whole or in part. Moreover, although FIG. 5 illustrates a particular number of client systems 530, social-networking systems 560, third-party systems 570, and networks 510, this disclosure contemplates any suitable number of client systems 530, social-networking systems 560, third-party systems 570, and networks 510. As an example and not by way of limitation, network environment 500 may include multiple client system 530, social-networking systems 560, third-party systems 570, and networks 510.

This disclosure contemplates any suitable network 510. As an example and not by way of limitation, one or more portions of network 510 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 510 may include one or more networks 510.

Links 550 may connect client system 530, social-networking system 560, and third-party system 570 to communication network 510 or to each other. This disclosure contemplates any suitable links 550. In particular embodiments, one or more links 550 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 550 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 550, or a combination of two or more such links 550. Links 550 need not necessarily be the same throughout network environment 500. One or more first links 550 may differ in one or more respects from one or more second links 550.

In particular embodiments, client system 530 may be an electronic device including hardware, software, or embedded logic components or a combination of two or more such components and capable of carrying out the appropriate functionalities implemented or supported by client system 530. As an example and not by way of limitation, a client system 530 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 530. A client system 530 may enable a network user at client system 530 to access network 510. A client system 530 may enable its user to communicate with other users at other client systems 530.

In particular embodiments, client system 530 may include a web browser 532, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 530 may enter a Uniform Resource Locator (URL) or other address directing the web browser 532 to a particular server (such as server 562, or a server associated with a third-party system 570), and the web browser 532 may generate a Hyper Text Transfer Protocol (HTTP) request and communicate the HTTP request to server. The server may accept the HTTP request and communicate to client system 530 one or more Hyper Text Markup Language (HTML) files responsive to the HTTP request. Client system 530 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 560 may be a network-addressable computing system that can host an online social network. Social-networking system 560 may generate, store, receive, and send social-networking data, such as, for example, user-profile data, concept-profile data, social-graph information, or other suitable data related to the online social network. Social-networking system 560 may be accessed by the other components of network environment 500 either directly or via network 510. As an example and not by way of limitation, client system 530 may access social-networking system 560 using a web browser 532, or a native application associated with social-networking system 560 (e.g., a mobile social-networking application, a messaging application, another suitable application, or any combination thereof) either directly or via network 510. In particular embodiments, social-networking system 560 may include one or more servers 562. Each server 562 may be a unitary server or a distributed server spanning multiple computers or multiple datacenters. Servers 562 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 562 may include hardware, software, or embedded logic components or a combination of two or more such components for carrying out the appropriate functionalities implemented or supported by server 562. In particular embodiments, social-networking system 560 may include one or more data stores 564. Data stores 564 may be used to store various types of information. In particular embodiments, the information stored in data stores 564 may be organized according to specific data structures. In particular embodiments, each data store 564 may be a relational, columnar, correlation, or other suitable database. Although this disclosure describes or illustrates particular types of databases, this disclosure contemplates any suitable types of databases. Particular embodiments may provide interfaces that enable a client system 530, a social-networking system 560, or a third-party system 570 to manage, retrieve, modify, add, or delete, the information stored in data store 564.

In particular embodiments, social-networking system 560 may store one or more social graphs in one or more data stores 564. In particular embodiments, a social graph may include multiple nodes—which may include multiple user nodes (each corresponding to a particular user) or multiple concept nodes (each corresponding to a particular concept)—and multiple edges connecting the nodes. Social-networking system 560 may provide users of the online social network the ability to communicate and interact with other users. In particular embodiments, users may join the online social network via social-networking system 560 and then add connections (e.g., relationships) to a number of other users of social-networking system 560 to whom they want to be connected. Herein, the term “friend” may refer to any other user of social-networking system 560 with whom a user has formed a connection, association, or relationship via social-networking system 560.

In particular embodiments, social-networking system 560 may provide users with the ability to take actions on various types of items or objects, supported by social-networking system 560. As an example and not by way of limitation, the items and objects may include groups or social networks to which users of social-networking system 560 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 560 or by an external system of third-party system 570, which is separate from social-networking system 560 and coupled to social-networking system 560 via a network 510.

In particular embodiments, social-networking system 560 may be capable of linking a variety of entities. As an example and not by way of limitation, social-networking system 560 may enable users to interact with each other as well as receive content from third-party systems 570 or other entities, or to allow users to interact with these entities through an application programming interfaces (API) or other communication channels.

In particular embodiments, a third-party system 570 may include one or more types of servers, one or more data stores, one or more interfaces, including but not limited to APIs, one or more web services, one or more content sources, one or more networks, or any other suitable components, e.g., that servers may communicate with. A third-party system 570 may be operated by a different entity from an entity operating social-networking system 560. In particular embodiments, however, social-networking system 560 and third-party systems 570 may operate in conjunction with each other to provide social-networking services to users of social-networking system 560 or third-party systems 570. In this sense, social-networking system 560 may provide a platform, or backbone, which other systems, such as third-party systems 570, may use to provide social-networking services and functionality to users across the Internet.

In particular embodiments, a third-party system 570 may include a third-party content object provider. A third-party content object provider may include one or more sources of content objects, which may be communicated to a client system 530. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 560 also includes user-generated content objects, which may enhance a user's interactions with social-networking system 560. User-generated content may include anything a user can add, upload, send, or “post” to social-networking system 560. As an example and not by way of limitation, a user communicates posts to social-networking system 560 from a client system 530. Posts may include data such as status updates or other textual data, location information, photos, videos, links, music or other similar data or media. Content may also be added to social-networking system 560 by a third-party through a “communication channel,” such as a newsfeed or stream.

In particular embodiments, social-networking system 560 may include a variety of servers, sub-systems, programs, modules, logs, and data stores. In particular embodiments, social-networking system 560 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 560 may also include suitable components such as network interfaces, security mechanisms, load balancers, failover servers, management-and-network-operations consoles, other suitable components, or any suitable combination thereof. In particular embodiments, social-networking system 560 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 560 to one or more client systems 530 or one or more third-party system 570 via network 510. The web server may include a mail server or other messaging functionality for receiving and routing messages between social-networking system 560 and one or more client systems 530. An API-request server may allow a third-party system 570 to access information from social-networking system 560 by calling one or more APIs. An action logger may be used to receive communications from a web server about a user's actions on or off social-networking system 560. In conjunction with the action log, a third-party-content-object log may be maintained of user exposures to third-party-content objects. A notification controller may provide information regarding content objects to a client system 530. Information may be pushed to a client system 530 as notifications, or information may be pulled from client system 530 responsive to a request received from client system 530. Authorization servers may be used to enforce one or more privacy settings of the users of social-networking system 560. A privacy setting of a user determines how particular information associated with a user can be shared. The authorization server may allow users to opt in to or opt out of having their actions logged by social-networking system 560 or shared with other systems (e.g., third-party system 570), such as, for example, by setting appropriate privacy settings. Third-party-content-object stores may be used to store content objects received from third parties, such as a third-party system 570. Location stores may be used for storing location information received from client systems 530 associated with users. Advertisement-pricing modules may combine social information, the current time, location information, or other suitable information to provide relevant advertisements, in the form of notifications, to a user.

Artificial Neural Networks

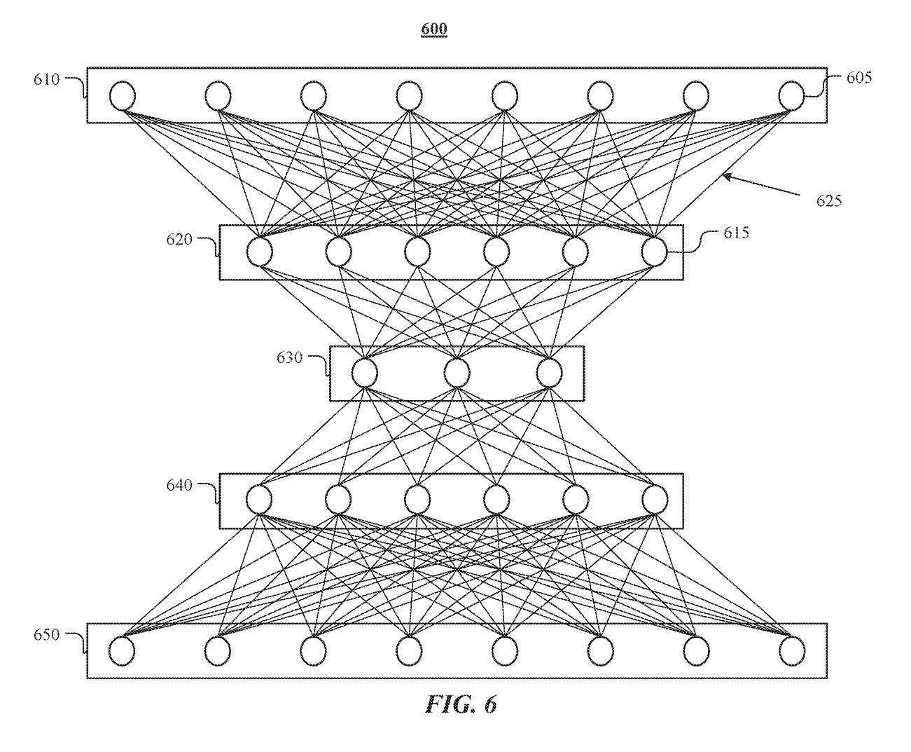

FIG. 6 illustrates an example artificial neural network (“ANN”) 600. In particular embodiments, an ANN may refer to a computational model comprising one or more nodes. Example ANN 600 may comprise an input layer 610, hidden layers 620, 630, 640, and an output layer 650. Each layer of the ANN 600 may comprise one or more nodes, such as a node 605 or a node 615. In particular embodiments, each node of an ANN may be connected to another node of the ANN. As an example and not by way of limitation, each node of the input layer 610 may be connected to one of more nodes of the hidden layer 620. In particular embodiments, one or more nodes may be a bias node (e.g., a node in a layer that is not connected to and does not receive input from any node in a previous layer). In particular embodiments, each node in each layer may be connected to one or more nodes of a previous or subsequent layer. Although FIG. 6 depicts a particular ANN with a particular number of layers, a particular number of nodes, and particular connections between nodes, this disclosure contemplates any suitable ANN with any suitable number of layers, any suitable number of nodes, and any suitable connections between nodes. As an example and not by way of limitation, although FIG. 6 depicts a connection between each node of the input layer 610 and each node of the hidden layer 620, one or more nodes of the input layer 610 may not be connected to one or more nodes of the hidden layer 620.

In particular embodiments, an ANN may be a feedforward ANN (e.g., an ANN with no cycles or loops where communication between nodes flows in one direction beginning with the input layer and proceeding to successive layers). As an example and not by way of limitation, the input to each node of the hidden layer 620 may comprise the output of one or more nodes of the input layer 610. As another example and not by way of limitation, the input to each node of the output layer 650 may comprise the output of one or more nodes of the hidden layer 640. In particular embodiments, an ANN may be a deep neural network (e.g., a neural network comprising at least two hidden layers). In particular embodiments, an ANN may be a deep residual network. A deep residual network may be a feedforward ANN comprising hidden layers organized into residual blocks. The input into each residual block after the first residual block may be a function of the output of the previous residual block and the input of the previous residual block. As an example and not by way of limitation, the input into residual block N may be F(x)+x, where F(x) may be the output of residual block N−1, x may be the input into residual block N−1. Although this disclosure describes a particular ANN, this disclosure contemplates any suitable ANN.

In particular embodiments, an activation function may correspond to each node of an ANN. An activation function of a node may define the output of a node for a given input. In particular embodiments, an input to a node may comprise a set of inputs. As an example and not by way of limitation, an activation function may be an identity function, a binary step function, a logistic function, or any other suitable function. As another example and not by way of limitation, an activation function for a node k may be the sigmoid function

$${F}_{k} ( {s}_{k} ) = \frac{1}{1 + {e}^{- {s}_{k}}} ,$$

the hyperbolic tangent function

$${F}_{k} ( {s}_{k} ) = \frac{{e}^{{s}_{k}} - {e}^{- {s}_{k}}}{{e}^{{s}_{k}} + {e}^{- {s}_{k}}} ,$$

the rectifier Fₖ(sₖ)=max(0,sₖ), or any other suitable function Fₖ(sₖ), where sₖ may be the effective input to node k. In particular embodiments, the input of an activation function corresponding to a node may be weighted. Each node may generate output using a corresponding activation function based on weighted inputs. In particular embodiments, each connection between nodes may be associated with a weight. As an example and not by way of limitation, a connection 625 between the node 605 and the node 615 may have a weighting coefficient of 0.4, which may indicate that 0.4 multiplied by the output of the node 605 is used as an input to the node 615. As another example and not by way of limitation, the output yₖ of node k may be yₖ Fₖ(sₖ), where Fₖ may be the activation function corresponding to node k, sₖ=Σⱼ(wⱼₖxⱼ) may be the effective input to node k, xⱼ may be the output of a node j connected to node k, and wⱼₖ may be the weighting coefficient between node j and node k. In particular embodiments, the input to nodes of the input layer may be based on a vector representing an object. Although this disclosure describes particular inputs to and outputs of nodes, this disclosure contemplates any suitable inputs to and outputs of nodes. Moreover, although this disclosure may describe particular connections and weights between nodes, this disclosure contemplates any suitable connections and weights between nodes.

In particular embodiments, an ANN may be trained using training data. As an example and not by way of limitation, training data may comprise inputs to the ANN 600 and an expected output. As another example and not by way of limitation, training data may comprise vectors each representing a training object and an expected label for each training object. In particular embodiments, training an ANN may comprise modifying the weights associated with the connections between nodes of the ANN by optimizing an objective function. As an example and not by way of limitation, a training method may be used (e.g., the conjugate gradient method, the gradient descent method, the stochastic gradient descent) to backpropagate the sum-of-squares error measured as a distances between each vector representing a training object (e.g., using a cost function that minimizes the sum-of-squares error). In particular embodiments, an ANN may be trained using a dropout technique. As an example and not by way of limitation, one or more nodes may be temporarily omitted (e.g., receive no input and generate no output) while training. For each training object, one or more nodes of the ANN may have some probability of being omitted. The nodes that are omitted for a particular training object may be different than the nodes omitted for other training objects (e.g., the nodes may be temporarily omitted on an object-by-object basis). Although this disclosure describes training an ANN in a particular manner, this disclosure contemplates training an ANN in any suitable manner.

### Social Graphs

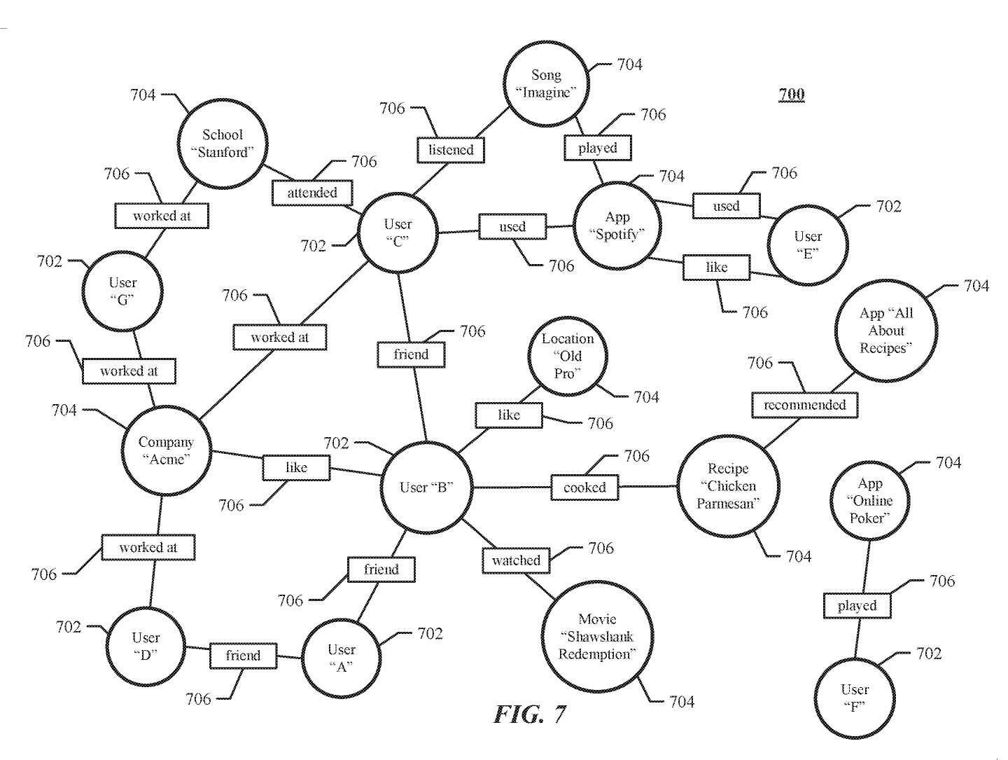

FIG. 7 illustrates example social graph 700. In particular embodiments, social-networking system 560 may store one or more social graphs 700 in one or more data stores. In particular embodiments, social graph 700 may include multiple nodes—which may include multiple user nodes 702 or multiple concept nodes 704—and multiple edges 706 connecting the nodes. Example social graph 700 illustrated in FIG. 7 is shown, for didactic purposes, in a two-dimensional visual map representation. In particular embodiments, a social-networking system 560, client system 530, or third-party system 570 may access social graph 700 and related social-graph information for suitable applications. The nodes and edges of social graph 700 may be stored as data objects, for example, in a data store (such as a social-graph database). Such a data store may include one or more searchable or queryable indexes of nodes or edges of social graph 700.

In particular embodiments, a user node 702 may correspond to a user of social-networking system 560. As an example and not by way of limitation, a user may be an individual (human user), an entity (e.g., an enterprise, business, or third-party application), or a group (e.g., of individuals or entities) that interacts or communicates with or over social-networking system 560. In particular embodiments, when a user registers for an account with social-networking system 560, social-networking system 560 may create a user node 702 corresponding to the user, and store the user node 702 in one or more data stores. Users and user nodes 702 described herein may, where appropriate, refer to registered users and user nodes 702 associated with registered users. In addition or as an alternative, users and user nodes 702 described herein may, where appropriate, refer to users that have not registered with social-networking system 560. In particular embodiments, a user node 702 may be associated with information provided by a user or information gathered by various systems, including social-networking system 560. As an example and not by way of limitation, a user may provide his or her name, profile picture, contact information, birth date, sex, marital status, family status, employment, education background, preferences, interests, or other demographic information. In particular embodiments, a user node 702 may be associated with one or more data objects corresponding to information associated with a user. In particular embodiments, a user node 702 may correspond to one or more webpages.

In particular embodiments, a concept node 704 may correspond to a concept. As an example and not by way of limitation, a concept may correspond to a place (such as, for example, a movie theater, restaurant, landmark, or city); a website (such as, for example, a website associated with social-network system 560 or a third-party website associated with a web-application server); an entity (such as, for example, a person, business, group, sports team, or celebrity); a resource (such as, for example, an audio file, video file, digital photo, text file, structured document, or application) which may be located within social-networking system 560 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 704 may be associated with information of a concept provided by a user or information gathered by various systems, including social-networking system 560. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 704 may be associated with one or more data objects corresponding to information associated with concept node 704. In particular embodiments, a concept node 704 may correspond to one or more webpages.

In particular embodiments, a node in social graph 700 may represent or be represented by a webpage (which may be referred to as a “profile page”). Profile pages may be hosted by or accessible to social-networking system 560. Profile pages may also be hosted on third-party websites associated with a third-party system 570. As an example and not by way of limitation, a profile page corresponding to a particular external webpage may be the particular external webpage and the profile page may correspond to a particular concept node 704. Profile pages may be viewable by all or a selected subset of other users. As an example and not by way of limitation, a user node 702 may have a corresponding user-profile page in which the corresponding user may add content, make declarations, or otherwise express himself or herself. As another example and not by way of limitation, a concept node 704 may have a corresponding concept-profile page in which one or more users may add content, make declarations, or express themselves, particularly in relation to the concept corresponding to concept node 704.

In particular embodiments, a concept node 704 may represent a third-party webpage or resource hosted by a third-party system 570. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 530 to send to social-networking system 560 a message indicating the user's action. In response to the message, social-networking system 560 may create an edge (e.g., a check-in-type edge) between a user node 702 corresponding to the user and a concept node 704 corresponding to the third-party webpage or resource and store edge 706 in one or more data stores.

In particular embodiments, a pair of nodes in social graph 700 may be connected to each other by one or more edges 706. An edge 706 connecting a pair of nodes may represent a relationship between the pair of nodes. In particular embodiments, an edge 706 may include or represent one or more data objects or attributes corresponding to the relationship between a pair of nodes. As an example and not by way of limitation, a first user may indicate that a second user is a “friend” of the first user. In response to this indication, social-networking system 560 may send a “friend request” to the second user. If the second user confirms the “friend request,” social-networking system 560 may create an edge 706 connecting the first user's user node 702 to the second user's user node 702 in social graph 700 and store edge 706 as social-graph information in one or more of data stores 564. In the example of FIG. 7, social graph 700 includes an edge 706 indicating a friend relation between user nodes 702 of user “A” and user “B” and an edge indicating a friend relation between user nodes 702 of user “C” and user “B.” Although this disclosure describes or illustrates particular edges 706 with particular attributes connecting particular user nodes 702, this disclosure contemplates any suitable edges 706 with any suitable attributes connecting user nodes 702. As an example and not by way of limitation, an edge 706 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 700 by one or more edges 706.

In particular embodiments, an edge 706 between a user node 702 and a concept node 704 may represent a particular action or activity performed by a user associated with user node 702 toward a concept associated with a concept node 704. As an example and not by way of limitation, as illustrated in FIG. 7, a user may “like,” “attended,” “played,” “listened,” “cooked,” “worked at,” or “watched” a concept, each of which may correspond to an edge type or subtype. A concept-profile page corresponding to a concept node 704 may include, for example, a selectable “check in” icon (such as, for example, a clickable “check in” icon) or a selectable “add to favorites” icon. Similarly, after a user clicks these icons, social-networking system 560 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 560 may create a “listened” edge 706 and a “used” edge (as illustrated in FIG. 7) between user nodes 702 corresponding to the user and concept nodes 704 corresponding to the song and application to indicate that the user listened to the song and used the application. Moreover, social-networking system 560 may create a “played” edge 706 (as illustrated in FIG. 7) between concept nodes 704 corresponding to the song and the application to indicate that the particular song was played by the particular application. In this case, “played” edge 706 corresponds to an action performed by an external application (SPOTIFY) on an external audio file (the song “Imagine”). Although this disclosure describes particular edges 706 with particular attributes connecting user nodes 702 and concept nodes 704, this disclosure contemplates any suitable edges 706 with any suitable attributes connecting user nodes 702 and concept nodes 704. Moreover, although this disclosure describes edges between a user node 702 and a concept node 704 representing a single relationship, this disclosure contemplates edges between a user node 702 and a concept node 704 representing one or more relationships. As an example and not by way of limitation, an edge 706 may represent both that a user likes and has used at a particular concept. Alternatively, another edge 706 may represent each type of relationship (or multiples of a single relationship) between a user node 702 and a concept node 704 (as illustrated in FIG. 7 between user node 702 for user “E” and concept node 704 for “SPOTIFY”).

In particular embodiments, social-networking system 560 may create an edge 706 between a user node 702 and a concept node 704 in social graph 700. As an example and not by way of limitation, a user viewing a concept-profile page (such as, for example, by using a web browser or a special-purpose application hosted by the user's client system 530) may indicate that he or she likes the concept represented by the concept node 704 by clicking or selecting a “Like” icon, which may cause the user's client system 530 to send to social-networking system 560 a message indicating the user's liking of the concept associated with the concept-profile page. In response to the message, social-networking system 560 may create an edge 706 between user node 702 associated with the user and concept node 704, as illustrated by “like” edge 706 between the user and concept node 704. In particular embodiments, social-networking system 560 may store an edge 706 in one or more data stores. In particular embodiments, an edge 706 may be automatically formed by social-networking system 560 in response to a particular user action. As an example and not by way of limitation, if a first user uploads a picture, watches a movie, or listens to a song, an edge 706 may be formed between user node 702 corresponding to the first user and concept nodes 704 corresponding to those concepts. Although this disclosure describes forming particular edges 706 in particular manners, this disclosure contemplates forming any suitable edges 706 in any suitable manner.

### Advertising

In particular embodiments, an advertisement may be text (which may be HTML-linked), one or more images (which may be HTML-linked), one or more videos, audio, other suitable digital object files, a suitable combination of these, or any other suitable advertisement in any suitable digital format presented on one or more web pages, in one or more e-mails, or in connection with search results requested by a user. In addition or as an alternative, an advertisement may be one or more sponsored stories (e.g., a news-feed or ticker item on social-networking system 560). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. The social action may be promoted within or on social-networking system 560. In addition or as an alternative, the social action may be promoted outside or off of social-networking system 560, where appropriate. In particular embodiments, a page may be an on-line presence (such as a webpage or website within or outside of social-networking system 560) of a business, organization, or brand facilitating its sharing of stories and connecting with people. A page may be customized, for example, by adding applications, posting stories, or hosting events.

A sponsored story may be generated from stories in users' news feeds and promoted to specific areas within displays of users' web browsers when viewing a web page associated with social-networking system 560. Sponsored stories are more likely to be viewed by users, at least in part because sponsored stories generally involve interactions or suggestions by the users' friends, fan pages, or other connections. In connection with sponsored stories, particular embodiments may utilize one or more systems, components, elements, functions, methods, operations, or steps disclosed in U.S. patent application Ser. No. 13/327,557, entitled “Sponsored Stories Unit Creation from Organic Activity Stream” and filed 15 Dec. 2011, U.S. Patent Application Publication No. 2012/0203831, entitled “Sponsored Stories Unit Creation from Organic Activity Stream” and filed 3 Feb. 2012 as U.S. patent application Ser. No. 13/020,745, or U.S. Patent Application Publication No. 2012/0233009, entitled “Endorsement Subscriptions for Sponsored Stories” and filed 9 Mar. 2011 as U.S. patent application Ser. No. 13/044,506, which are all incorporated herein by reference as an example and not by way of limitation. In particular embodiments, sponsored stories may utilize computer-vision algorithms to detect products in uploaded images or photos lacking an explicit connection to an advertiser as disclosed in U.S. patent application Ser. No. 13/212,356, entitled “Computer-Vision Content Detection for Sponsored Stories” and filed 18 Aug. 2011, which is incorporated herein by reference as an example and not by way of limitation.

As described above, an advertisement may be text (which may be HTML-linked), one or more images (which may be HTML-linked), one or more videos, audio, one or more ADOBE FLASH files, a suitable combination of these, or any other suitable advertisement in any suitable digital format. In particular embodiments, an advertisement may be requested for display within third-party webpages, social-networking-system webpages, or other pages. An advertisement may be displayed in a dedicated portion of a page, such as in a banner area at the top of the page, in a column at the side of the page, in a GUI of the page, in a pop-up window, over the top of content of the page, or elsewhere with respect to the page. In addition or as an alternative, an advertisement may be displayed within an application or within a game. An advertisement may be displayed within dedicated pages, requiring the user to interact with or watch the advertisement before the user may access a page, utilize an application, or play a game. The user may, for example view the advertisement through a web browser.

A user may interact with an advertisement in any suitable manner. The user may click or otherwise select the advertisement, and the advertisement may direct the user (or a browser or other application being used by the user) to a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). In particular embodiments, an advertisement may include one or more games, which a user or other application may play in connection with the advertisement. An advertisement may include functionality for responding to a poll or question in the advertisement.

An advertisement may include social-networking-system functionality that a user may interact with. For example, an advertisement may enable a user to “like” or otherwise endorse the advertisement by selecting an icon or link associated with endorsement. Similarly, a user may share the advertisement with another user (e.g., through social-networking system 560) or RSVP (e.g., through social-networking system 560) to an event associated with the advertisement. In addition or as an alternative, an advertisement may include social-networking-system content directed to the user. For example, an advertisement may display information about a friend of the user within social-networking system 560 who has taken an action associated with the subject matter of the advertisement.

Social-networking-system functionality or content may be associated with an advertisement in any suitable manner. For example, an advertising system (which may include hardware, software, or both for receiving bids for advertisements and selecting advertisements in response) may retrieve social-networking functionality or content from social-networking system 560 and incorporate the retrieved social-networking functionality or content into the advertisement before serving the advertisement to a user. Examples of selecting and providing social-networking-system functionality or content with an advertisement are disclosed in U.S. Patent Application Publication No. 2012/0084160, entitled “Providing Social Endorsements with Online Advertising” and filed 5 Oct. 2010 as U.S. patent application Ser. No. 12/898,662, and in U.S. Patent Application Publication No. 2012/0232998, entitled “Selecting Social Endorsement Information for an Advertisement for Display to a Viewing User” and filed 8 Mar. 2011 as U.S. patent application Ser. No. 13/043,424, which are both incorporated herein by reference as examples only and not by way of limitation. Interacting with an advertisement that is associated with social-networking-system functionality or content may cause information about the interaction to be displayed in a profile page of the user in social-networking-system 560.

Particular embodiments may facilitate the delivery of advertisements to users that are more likely to find the advertisements more relevant or useful. For example, an advertiser may realize higher conversion rates (and therefore higher return on investment (ROI) from advertising) by identifying and targeting users that are more likely to find its advertisements more relevant or useful. The advertiser may use user-profile information in social-networking system 560 to identify those users. In addition or as an alternative, social-networking system 560 may use user-profile information in social-networking system 560 to identify those users for the advertiser. As examples and not by way of limitation, particular embodiments may target users with the following: invitations or suggestions of events; suggestions regarding coupons, deals, or wish-list items; suggestions regarding friends' life events; suggestions regarding groups; advertisements; or social advertisements. Such targeting may occur, where appropriate, on or within social-networking system 560, off or outside of social-networking system 560, or on mobile computing devices of users. When on or within social-networking system 560, such targeting may be directed to users' news feeds, search results, e-mail or other in-boxes, or notifications channels or may appear in particular area of web pages of social-networking system 560, such as a right-hand side of a web page in a concierge or grouper area (which may group along a right-hand rail advertisements associated with the same concept, node, or object) or a network-ego area (which may be based on what a user is viewing on the web page and a current news feed of the user). When off or outside of social-networking system 560, such targeting may be provided through a third-party website, e.g., involving an ad exchange or a social plug-in. When on a mobile computing device of a user, such targeting may be provided through push notifications to the mobile computing device.

Targeting criteria used to identify and target users may include explicit, stated user interests on social-networking system 560 or explicit connections of a user to a node, object, entity, brand, or page on social-networking system 560. In addition or as an alternative, such targeting criteria may include implicit or inferred user interests or connections (which may include analyzing a user's history, demographic, social or other activities, friends' social or other activities, subscriptions, or any of the preceding of other users similar to the user (based, e.g., on shared interests, connections, or events)). Particular embodiments may utilize platform targeting, which may involve platform and “like” impression data; contextual signals (e.g., “Who is viewing now or has viewed recently the page for COCA-COLA?”); light-weight connections (e.g., “check-ins”); connection lookalikes; fans; extracted keywords; EMU advertising; inferential advertising; coefficients, affinities, or other social-graph information; friends-of-friends connections; pinning or boosting; deals; polls; household income, social clusters or groups; products detected in images or other media; social- or open-graph edge types; geo-prediction; views of profile or pages; status updates or other user posts (analysis of which may involve natural-language processing or keyword extraction); events information; or collaborative filtering. Identifying and targeting users may also include privacy settings (such as user opt-outs), data hashing, or data anonymization, as appropriate.

To target users with advertisements, particular embodiments may utilize one or more systems, components, elements, functions, methods, operations, or steps disclosed in the following, which are all incorporated herein by reference as examples and not by way of limitation: U.S. Patent Application Publication No. 2009/0119167, entitled “Social Advertisements and Other Informational Messages on a Social Networking Website and Advertising Model for Same” and filed 18 Aug. 2008 as U.S. patent application Ser. No. 12/193,702; U.S. Patent Application Publication No. 2009/0070219, entitled “Targeting Advertisements in a Social Network” and filed 20 Aug. 2008 as U.S. patent application Ser. No. 12/195,321; U.S. Patent Application Publication No. 2012/0158501, entitled “Targeting Social Advertising to Friends of Users Who Have Interacted With an Object Associated with the Advertising” and filed 15 Dec. 2010 as U.S. patent application Ser. No. 12/968,786; or U.S. Patent Application Publication No. 2012/0166532, entitled “Contextually Relevant Affinity Prediction in a Social-Networking System” and filed 23 Dec. 2010 as U.S. patent application Ser. No. 12/978,265.

An advertisement may be presented or otherwise delivered using plug-ins for web browsers or other applications, iframe elements, news feeds, tickers, notifications (which may include, for example, e-mail, Short Message Service (SMS) messages, or notifications), or other means. An advertisement may be presented or otherwise delivered to a user on a mobile or other computing device of the user. In connection with delivering advertisements, particular embodiments may utilize one or more systems, components, elements, functions, methods, operations, or steps disclosed in the following, which are all incorporated herein by reference as examples and not by way of limitation: U.S. Patent Application Publication No. 2012/0159635, entitled “Comment Plug-In for Third-Party System” and filed 15 Dec. 2010 as U.S. patent application Ser. No. 12/969,368; U.S. Patent Application Publication No. 2012/0158753, entitled “Comment Ordering System” and filed 15 Dec. 2010 as U.S. patent application Ser. No. 12/969,408; U.S. Pat. No. 7,669,123, entitled “Dynamically Providing a News Feed About a User of a Social Network” and filed 11 Aug. 2006 as U.S. patent application Ser. No. 11/503,242; U.S. Pat. No. 8,402,094, entitled “Providing a Newsfeed Based on User Affinity for Entities and Monitored Actions in a Social Network Environment” and filed 11 Aug. 2006 as U.S. patent application Ser. No. 11/503,093; U.S. Patent Application Publication No. 2012/0072428, entitled “Action Clustering for News Feeds” and filed 16 Sep. 2010 as U.S. patent application Ser. No. 12/˜˜4010; U.S. Patent Application Publication No. 2011/0004692, entitled “Gathering Information about Connections in a Social Networking Service” and filed 1 Jul. 2009 as U.S. patent application Ser. No. 12/496,606; U.S. Patent Application Publication No. 2008/0065701, entitled “Method and System for Tracking Changes to User Content in an Online Social Network” and filed 12 Sep. 2006 as U.S. patent application Ser. No. 11/531,154; U.S. Patent Application Publication No. 2008/0065604, entitled “Feeding Updates to Landing Pages of Users of an Online Social Network from External Sources” and filed 17 Jan. 2007 as U.S. patent application Ser. No. 11/6240˜˜, U.S. Pat. No. 8,244,848, entitled “Integrated Social-Network Environment” and filed 19 Apr. 2010 as U.S. patent application Ser. No. 12/763,171; U.S. Patent Application Publication No. 2011/0083101, entitled “Sharing of Location-Based Content Item in Social-Networking Service” and filed 6 Oct. 2009 as U.S. patent application Ser. No. 12/574,614; U.S. Pat. No. 8,150,844, entitled “Location Ranking Using Social-Graph Information” and filed 18 Aug. 2010 as U.S. patent application Ser. No. 12/858,718; U.S. patent application Ser. No. 13/051,286, entitled “Sending Notifications to Users Based on Users' Notification Tolerance Levels” and filed 18 Mar. 2011; U.S. patent application Ser. No. 13/096,184, entitled “Managing Notifications Pushed to User Devices” and filed 28 Apr. 2011; U.S. patent application Ser. No. 13/276,248, entitled “Platform-Specific Notification Delivery Channel” and filed 18 Oct. 2011; or U.S. Patent Application Publication No. 2012/0197709, entitled “Mobile Advertisement with Social Component for Geo-Social Networking System” and filed 1 Feb. 2011 as U.S. patent application Ser. No. 13/019,061. Although this disclosure describes or illustrates particular advertisements being delivered in particular ways and in connection with particular content, this disclosure contemplates any suitable advertisements delivered in any suitable ways and in connection with any suitable content.

Privacy

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 704 corresponding to a particular photo may have a privacy setting specifying that the photo may only be accessed by users tagged in the photo and their friends. In particular embodiments, privacy settings may allow users to opt in or opt out of having their actions logged by social-networking system 560 or shared with other systems (e.g., third-party system 570). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 570, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 562 may be authorization/privacy servers for enforcing privacy settings. In response to a request from a user (or other entity) for a particular object stored in a data store 564, social-networking system 560 may send a request to the data store 564 for the object. The request may identify the user associated with the request and may only be sent to the user (or a client system 530 of the user) if the authorization server determines that the user is authorized to access the object based on the privacy settings associated with the object. If the requesting user is not authorized to access the object, the authorization server may prevent the requested object from being retrieved from the data store 564, or may prevent the requested object from being sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

Systems and Methods

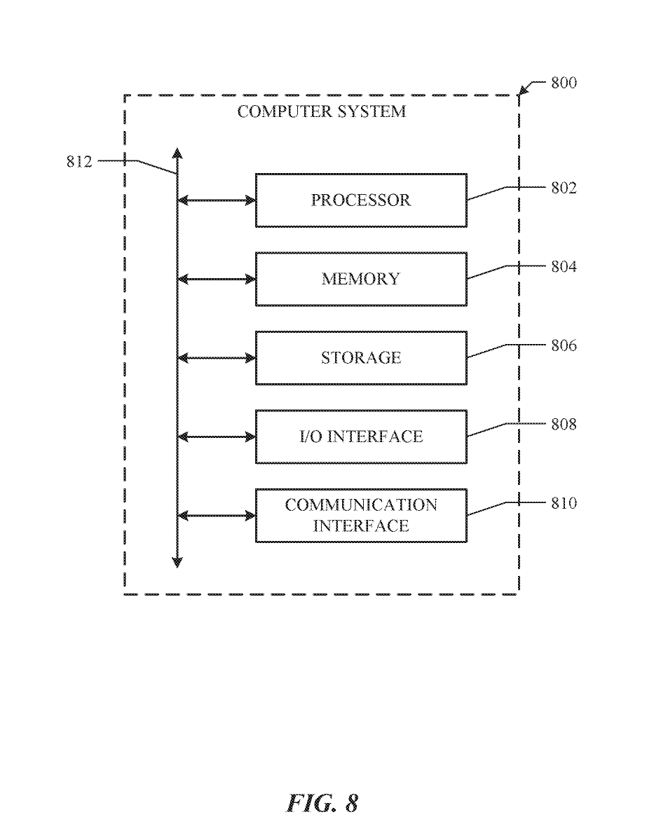

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein.

One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
by a first computing device in an online social network, receiving, from a second computing device, a request to create a post, the post comprising a link to a landing page outside the online social network and one or more words associated with the link in the post;
by the first computing device, classifying the link based on the one or more words, wherein the classification selects one of a plurality of pre-determined classes, and wherein each class is associated with particular expected content of the landing page;
by the first computing device, analyzing data from the landing page to generate a determination whether content of the landing page corresponds to the selected class; and
by the first computing device, assigning a rank to the link based on the determination.

2. The method of claim 1, further comprising:
computing a probability that particular users of the online social network will click the link, wherein the post is only presented to the particular users when the probability satisfies a first threshold.

3. The method of claim 2, wherein the post is presented in newsfeeds of the particular users.

4. The method of claim 2, wherein the post is presented in search results of the particular users if the post is relevant to search queries from the selected users.

5. The method of claim 1, wherein the link is not presented to users in the online social network if the assigned rank does not satisfy a second threshold.

6. The method of claim 1, wherein the class for the link is determined by analyzing a context of the one or more words.

7. The method of claim 1, wherein the data comprises html, text, images, embedding codes, or embedded links.

8. The method of claim 1, wherein the determination is based on a code snippet in html of the landing page, wherein the code snippet was provided by the online social network to the second computing device, wherein the code snippet provides meta-tags describing content of the landing page.

9. The method of claim 1, wherein the determination is based on an output of a logistic regression model, wherein the logistic regression model takes the data and the selected class as input and produces a probability that content of the landing page corresponds to the class.

10. The method of claim 9, wherein content of the landing page is determined to correspond to the class if the probability satisfies a third threshold.

11. The method of claim 9, wherein the logistic regression model utilizes Machine Learning (ML) techniques to classify content of the landing page.

12. The method of claim 11, wherein the ML techniques comprise Natural Language Processing (NLP)-based text-mining algorithms.

13. The method of claim 11, wherein the ML techniques comprise image detection algorithms or video detection algorithms.

14. The method of claim 11, wherein the logistic regression model is trained with a large corpus of training data, wherein the training data comprises both positive training data and negative training data.

15. The method of claim 14, wherein the logistic regression model is trained per each of the pre-determined classes.

16. The method of claim 15, wherein the positive training data for a particular class is collected from third-party web pages that correspond to the particular class, and wherein the negative training data for the particular class is collected from third-party web pages that do not correspond to the particular class.

17. The method of claim 5, further comprising:
sending, to the second computing device, in response to the request, a response comprising the assigned rank.

18. The method of claim 17, wherein the response includes a description of one or more parameters that negatively impacted the rank.

19. One or more computer-readable non-transitory storage media embodying software that is operable when executed to:
receive, from a second computing device, a request to create a post, the post comprising a link to a landing page outside the online social network and one or more words associated with the link in the post;
classify the link based on the one or more words, wherein the classification selects one of a plurality of pre-determined classes, and wherein each class is associated with particular expected content of the landing page;
analyze data from the landing page to generate a determination whether content of the landing page corresponds to the selected class; and
assign a rank to the link based on the determination.

20. A system comprising:
one or more processors; and
one or more computer-readable non-transitory storage media coupled to one or more of the processors and comprising instructions operable when executed by one or more of the processors to cause the system to:
receive, from a second computing device, a request to create a post, the post comprising a link to a landing page outside the online social network and one or more words associated with the link in the post;
classify the link based on the one or more words, wherein the classification selects one of a plurality of pre-determined classes, and wherein each class is associated with particular expected content of the landing page;
analyze data from the landing page to generate a determination whether content of the landing page corresponds to the selected class; and
assign a rank to the link based on the determination.
